(19) United States
(12) Patent Application Publication
(10) Pub. No.: US 2008/0125312 A1
(43) Pub. Date: May 29, 2008

(54) Method of Modifying Properties of Nanoparticles

(75) Inventor: Avetik Harutyunyan, Columbus, OH (US)

Correspondence Address: PRASS & IRVING, LLP, 2661 RIVA ROAD, BUILDING 1000, SUITE 1044, ANNAPOLIS, MD, 21401, US

(73) Assignee: Honda Motor Co., Ltd., Tokyo (JP)

(21) Appl. No.: 11/941,594

(22) Filed: Nov. 16, 2007

Related U.S. Application Data
(60) Provisional application No. 60/860,497, filed on Nov. 22, 2006.

(51) Int. Cl. B01J 23/00; B01J 21/06; B01J 21/08; B01J 23/06; B01J 23/08; B01J 23/14; B01J 23/20; B01J 23/26; B01J 23/28; B01J 23/30; B01J 23/34; B01J 23/36; B01J 23/42; B01J 23/44; B01J 23/46; B01J 23/50; B01J 23/52; B01J 23/72; B01J 23/745; B01J 23/75; B01J 23/755

(52) U.S. Cl. 502/232; 502/100; 502/305; 502/319; 502/321; 502/324; 502/337; 502/338; 502/339; 502/325; 502/343; 502/340; 502/344; 502/345; 502/347; 502/350; 502/352; 502/349; 502/353; 502/355; 502/300

(57) ABSTRACT

The present teachings are directed toward methods of modifying the properties of a composition by providing particles of a first composition having dimensions of less than about 3 nanometers and a substrate of a second composition. The particles of the first composition are placed on the substrate, whereby the particles of the first composition and the substrate interact to modify at least one property of the particles of the first composition relative to the same property of particles of the first composition having dimensions greater than about 10 nanometers placed on a substrate of the second composition.

### RELATED APPLICATIONS

The present application claims benefit from earlier filed U.S. Provisional Application No. 60/860,497, filed Nov. 22, 2006, which is incorporated herein in its entirety by reference for all purposes.

### BACKGROUND

1. Field of the Invention

The present teachings relate to methods of modifying or tuning the properties of nanosized particles through interaction with a substrate or support material. Also presented are compositions containing nanoparticles that have their properties modified by interaction with a substrate or support material.

2. Discussion of the Related Art

Previous studies have shown that the melting temperatures of nanoparticles, with diameters generally greater than about 3 nanometers, embedded in an aluminum matrix can be depressed as an inverse function of the particle size of the embedded nanoparticles. Likewise the freezing temperatures of the embedded nanoparticles can be influenced by the size of the embedded particle. See Sheng et al., “Melting and Freezing Behavior of Embedded Nanoparticles in Ball-Milled Al-10 Wt % M (M=In, Sn, Bi, Cd, Pb) Mixtures,” Acta. Mater. Vol. 46, No. 14, pp. 5195-5205 (1998). In the Sheng study, the embedded nanoparticles had average diameters ranging from 13 to 22 nanometers obtained by ball-milling the particles into an aluminum matrix.

The effects of particle sizes less than about 3 nanometers and the interaction of such a particle with a substrate on the particle properties was not examined in the Sheng article.

Doping one material with another material, a dopant, is a method of changing the electronic, and crystallographic structure of the doped material. However, the changes in both electronic and crystallographic structures are not always controllable.

A need exists for further understanding of the effects of particle size on properties of nanoparticles, particularly when the nanoparticles are less than about 3 nanometers, and the effects of the nanoparticle's interaction with a substrate on the nanoparticle's properties.

### SUMMARY

The present disclosure is directed to methods of modifying the properties of the particles having average dimensions of less than about 3 nanometers through controlling particle size and substrate-particle interaction.

The present teachings meet the needs for a method of modifying the properties of a composition by providing particles of a first composition having dimensions of less than about 3 nanometers and a substrate of a second composition. The particles of the first composition are then placed on the substrate, so that the particles of the first composition and the substrate interact to change at least one property of the particles of the first composition relative to the same property of particles of the first composition having dimensions greater than about 10 nanometers placed on a substrate of the second composition.

The present teachings also provide a method of modifying the properties of a material by selecting a first material and a support material, providing particles of the first material having dimensions of less than about 3 nanometers and a substrate of the support material, and then contacting the particles of the first material with the substrate of the support material. Upon contact the particles of the first material and the substrate interact. The first material and the support material are both selected so that when the first material is contacted with the support material, at least one property of the first material is modified to thereby exhibit at least one property similar to a property of particles of a second material having dimensions of greater than about 10 nanometers.

Also provided by the present teachings is a method of tuning the performance of catalyst material including providing particles of a first catalyst composition having dimensions of less than about 3 nanometers, and a first and a second support material. Particles of the first catalyst composition are then contacted respectively with the first and the second support materials. The contact between the particles of the catalyst composition and each of the support materials modifies the catalyst performance of the particles of the first catalyst composition.

A composition is also provided by the present teachings. The composition contains particles of a first component having dimensions of less than about 3 nanometers, and a substrate of a first support material. The particles and the substrate are in contact with one another, and at least one property of the particles of the first component is changed by the contact with the substrate relative to the property of particles of the first component having dimensions greater than about 10 nanometers in contact with the substrate.

Unexpectedly, the present disclosure has found that decreasing the size of particles to less than about 3 nanometers provides for changes in properties that appear to be defined by the interaction of the particle with the substrate. Without being limited thereto, the interaction between the nanoparticle and the substrate is believed to modify the electronic structure of the nanoparticle which changes the properties of the nanoparticle itself. By changing the substrate and nanoparticle interaction, through selection of these two components, the properties of the nanoparticle can be adjusted as desired.

### BRIEF DESCRIPTION OF THE DRAWINGS

The accompanying drawings which are included to provide a further understanding of the present disclosure and are incorporated in and constitute a part of this specification, illustrate various embodiments of the present disclosure and together with the detailed description serve to explain the principles of the present disclosure. In the drawings:

FIG. 1(A) is a graph of the particle size distribution and 1(B) is a electron microphotograph of iron particles prepared from a solution of 0.2 mg Fe(NO₃)₃9H₂O dissolved in 20 mL hexane;

FIG. 2(A) is a graph of the particle size distribution and 2(B) is a electron microphotograph of iron particles prepared from a solution of 0.5 mg Fe(NO₃)₃9H₂O dissolved in 20 mL hexane;

FIG. 3(A) is a graph of the particle size distribution and 3(B) is a electron microphotograph of iron particles prepared from a solution of 1.0 mg Fe(NO₃)₃9H₂O dissolved in 20 mL hexane, and

FIG. 4 is a plot of the hydrogen concentration versus temperature for methane decomposition.

### DETAILED DESCRIPTION

The present teachings are directed to methods and materials related to the modification of material properties when the materials are in the form of particles having dimensions of less than about 3 nanometers and placed on, that is, are in contact with a substrate.

One embodiment of the present teachings includes a method of modifying the properties of a composition by providing particles of a first composition having dimensions of less than about 3 nanometers and a substrate of a second composition. The particles of the first composition are then placed on the substrate, in such a manner that the particles of the first composition and the substrate interact to modify at least one property of the particles of the first composition relative to the same property of particles of the first composition having dimensions greater than about 10 nanometers placed on a substrate of the second composition.

In this method, the modified property of the first composition can be, for instance, melting point, condensation point, electronic structure and catalytic activity.

The first composition can be comprised of two or more elements, or only one element. The element(s) can be selected from the group consisting of any metal, and can include, for example, and without limitation, scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead.

According to the present method, the particles of the first composition can have dimensions of less than about 2 nanometers, or in additional embodiments, the particles of the first composition can have dimensions of less than about 1 nanometer.

The second composition can be at least one oxide selected from the group consisting of the oxides of, for instance, magnesium, aluminum, silicon, gallium, germanium, yttrium and zirconium. Suitable oxides can be those oxides that form essentially no covalent bonds with the particle of the first composition.

According to another embodiment of the present teachings, a method of modifying the properties of a material is provided. The method comprises selecting a first material and a support material, and providing particles of the first material having dimensions of less than about 3 nanometers and a substrate of the support material. The particles of the first material are then contacted with the substrate of the support material to cause an interaction between the particles of the first material and the substrate. The first material and the support material are both selected so that when the first material is contacted with the support material, at least one property of the first material is modified to thereby exhibit at least one property similar to a property of particles of a second material having dimensions of greater than about 10 nanometers.

The particles of the second material greater than about 10 nanometers can interact with a substrate of the support material, or can be supported on a substrate of the support material.

The modified property of the first material can be thermodynamic properties or electronic properties and can include, for instance, melting point, condensation point, electronic structure and catalytic activity.

The first material can be made of two or more elements, or only one element. In instances when there are two or more elements present in the first material, the two or more elements can be in the form of an alloy.

According to the present method, the first material can contain at least one element selected from the group consisting of for example, and without limitation, scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead. The particles of the first material can have dimensions of less than about 2 nanometers, or, in some cases, dimensions of less than about 1 nanometer. The dimensions of the particles of the first material should be small enough so that the interaction with the substrate support material causes at least one observable property of the first material to be changed.

The support material can include, for example, the oxides of magnesium, aluminum, silicon, gallium, germanium, yttrium and zirconium.

The second material can be, for instance, a material that is more catalytically active than the selected first material, or a material that is less plentiful than the selected first material, or a material that is more difficult to obtain than the selected first material, or a material that is more resistant to catalyst poisoning than the selected first material. Preferably, the second material is a material that typically has advantageous properties over the first material when the first material has dimensions greater than about 3 nanometers and is not interacting with a substrate, as described above. In some embodiments of the present method, the second material can include, for instance, ruthenium, rhodium, palladium, silver, iridium, platinum and gold.

The present teachings also provide a method of tuning the performance of catalyst material by providing particles of a first catalyst composition having dimensions of less than about 3 nanometers and both a first and a second support material. The particles of the first catalyst composition are contacted with both the first support material and the second support material, respectively. The contact between the particles of the first catalyst composition and each of the support materials modifies the catalyst performance of the particles of the first catalyst composition. Preferably the catalyst performance of the particles of the first catalyst composition are modified to varying degrees.

According to some embodiments of the present method, the first catalyst composition can include only one element, or can be comprised of two or more elements. In some instances the first catalyst composition can be an alloy formed from two or more elements present.

The first catalyst composition can be, for this present method, for example and without limitation, scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead.

In some embodiments of the present method, the particles of the first catalyst composition can have dimensions of less than about 2 nanometers, preferably the particles are small enough to allow for the interaction with the substrate to modify the desired properties of the first catalyst composition. In some instances of this present method, the particles of the first catalyst composition can have dimensions of less than about 1 nanometer.

The method according to the present teachings can have each of the first support material and the second support material independently include at least one oxide selected from the group consisting of the oxides of magnesium, aluminum, silicon, gallium, germanium, yttrium and zirconium.

The catalytic performance of the modified first catalyst composition can be similar to the catalytic performance of a second catalyst composition. For instance, particles of a first element, such as iron, with a particle size of less than about 3 nanometers placed on a substrate of a second composition can have the same catalytic performance as particles of a second element, such as rhodium, when the particles of the second element are greater than about 10 nanometers.

The catalytic performance of the first catalyst composition can be modified by the substrate material. The catalyst compositions taught by present method can be utilized for a wide variety of applications, such as, for example, fuel cells, hydrogen storage, water gas shift, hydrogenation, dehydrogenation, and various functionalization reactions of hydrocarbons.

Also taught by the present disclosure is a composition composed of particles of a component having dimensions of less than about 3 nanometers, and a substrate of a support material. The particles and the substrate are in contact with one another, and at least one property of the particles of the component is changed by the contact with the substrate relative to the property of particles of the component having dimensions greater than about 10 nanometers in contact with the substrate.

In the composition according to the present teachings, the component can contain two or more elements, or only one element, with the element(s) selected from, for example, and without limitation, scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead. The component particles can have dimensions of less than about 2 nanometers, and in some instances, dimensions of less than about 1 nanometer.

The support material comprises at least one oxide selected from the group consisting of the oxides of magnesium, aluminum, silicon, gallium, germanium, yttrium and zirconium.

Preparation of the Compositions Utilized in the Present Disclosure can be Achieved by various known routes. The substrate or support material can be obtained commercially, if suitable, or can be prepared. A suitable substrate or support material is a material that will provide a surface on which the nanoparticles can be deposited or grown. The nanoparticles can prepared by any suitable preparative route including for example, wet chemical means, plasma or laser-driven gas phase reactions, evaporation-condensation mechanisms, thermal decomposition. The nanoparticles can be grown directly on the substrate, or can be deposited from a liquid or gaseous solution onto the substrate. Various suitable preparative methods are set forth in U.S. Pat. Nos. 6,974,492 B2 and 6,974,493 B2.

Separation or dilution of the nanoparticles across the surface of the substrate can be one approach to limiting the effects of agglomeration or sintering of the nanoparticles. Particularly upon exposure to elevated temperatures, particles can begin to agglomerate and form larger size particles on the surface. This agglomeration can impact the properties of the particles. Diluting or separating the nanoparticles on the surface of the substrate can improve resistance to agglomeration. Stabilization of the nanoparticles on the surface of the substrate can be achieved by use of, for instance, chemical stabilizers to increase bonding between the nanoparticle and the substrate.

As used herein, “changed” or “modified”, with respect to the effect of the contact between the particles having dimensions of less than about 3 nanometers and the substrate or support material on the properties of the particles, means that the value of a property of the particles having dimensions of less than about 3 nanometers is changed or modified to an extent that the value of the property is similar to properties of particles of a different composition having dimensions of greater than about 10 nanometers. As used herein, “similar” means within about 5% of the value of the property of particles of a different composition having dimensions of greater than about 10 nanometers.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The following examples are presented to provide a more complete understanding of the present teachings. The specific techniques, conditions, materials, and reported data set forth to illustrate the principles of the principles of the present teachings are exemplary and should not be construed as limiting the scope of the present teachings.

### EXAMPLES

### Example 1

Fe(NO₃)₃9H₂O (99.999%, Alpha AESAR) was dissolved in methanol and mixed thoroughly for one hour with a methanol suspension of alumina (99.9%, Alpha AESAR). The solvent was then evaporated and the resultant cake heated to 90-100° C. for three hours under a nitrogen gas flow. The cake was then removed from the furnace and ground in an agate mortar. The resulting fine powder was then calcined for one hour at 500° C. The particle size was estimated by using SQUID magnetometer (MPMS, Quantum Design) based on their blocking temperature value (TB) or Langevin function analysis following the description set forth in A. R. Harutyunyan et al., Journal Of Applied Physics, Vol. 100, p. 044321 (2006).

### Example 2

Fe₂(SO₄)₃5H₂O (99.999%, Alpha AESAR) was dissolved in methanol and mixed thoroughly for one hour with a methanol suspension of alumina (99.9%, Alpha AESAR). The solvent was then evaporated and the resultant cake heated to 90-100° C. for three hours under a nitrogen gas flow. The cake was then removed from the furnace and ground in an agate mortar. The resulting fine powder was then calcined for one hour at 500° C. The particle size was estimated by using SQUID magnetometer (MPMS, Quantum Design) based on their blocking temperature value (TB) or Langevin function analysis following the description set forth in A. R. Harutyunyan et al., Journal Of Applied Physics, Vol. 100, p. 044321 (2006).

### Example 3

A solution of Fe(NO₃)₃9H₂O (99.999%, Alpha AESAR) in 2-propanol was prepared and stirred for 10 minutes. Then a silicon dioxide substrate was dipped into the solution for 20 seconds with then rinsed in hexane. The substrate was dried at about 110° C. and placed in quartz tube furnace, length 90 cm and diameter 5 cm, for calcination. After calcination at about 500° C. for 1 hour under a dry air flow, the substrate was removed and the particle size measured by AFM. The particle size can be varied by using different molar ratios of Fe nitrate and 2-propanol.

### Example 4

Solutions of iron nitrate were prepared by dissolving 0.2 mg, 0.5 mg, and 1.0 mg of Fe(NO₃)₃9H₂O (99.999%, Alpha AESAR) into 20 mL aliquots of hexane, respectively. Silicon dioxide substrates were dipped into each solution for 20 seconds with then rinsed in hexane. The substrates were dried at about 110° C. and placed in quartz tube furnace, length 90 cm and diameter 5 cm, for calcination. After calcination at about 500° C. for 1 hour under a dry air flow, the substrates were removed and the particle size and size distribution measured by AFM.

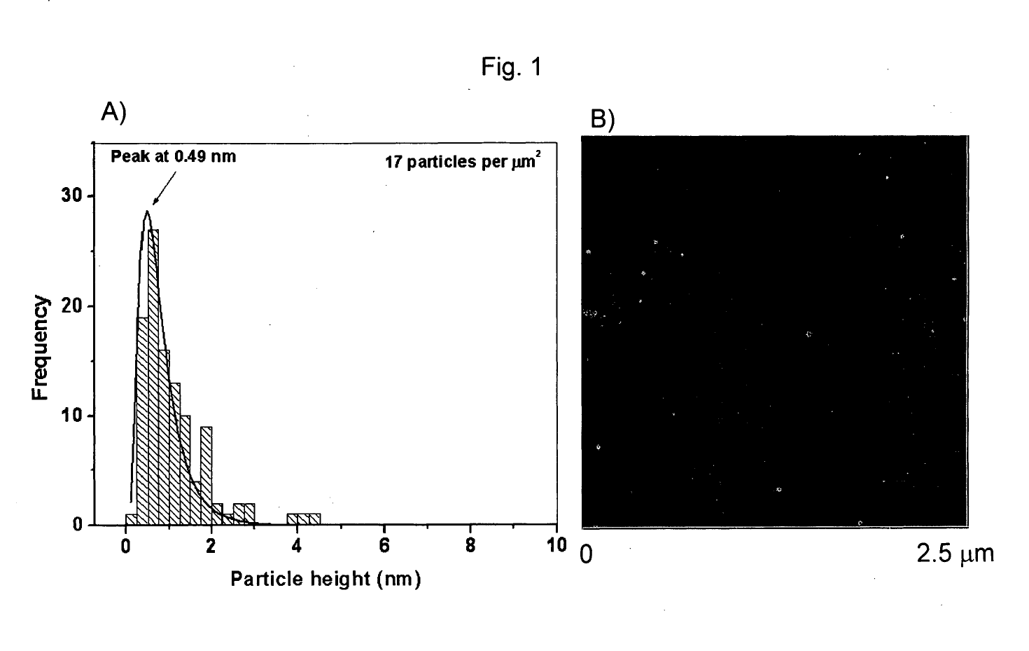

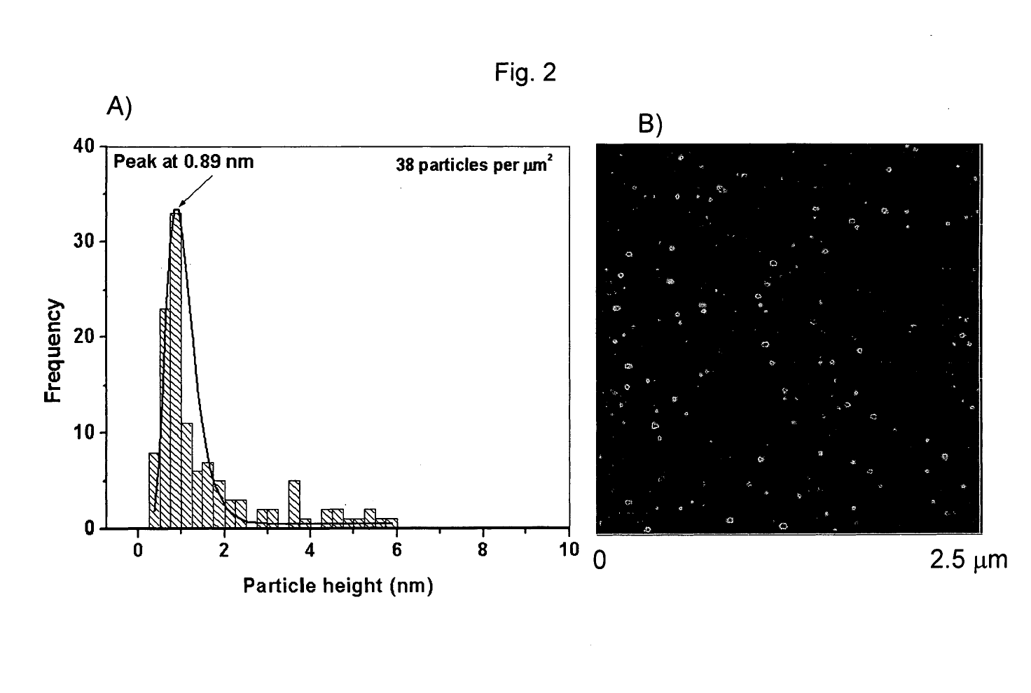

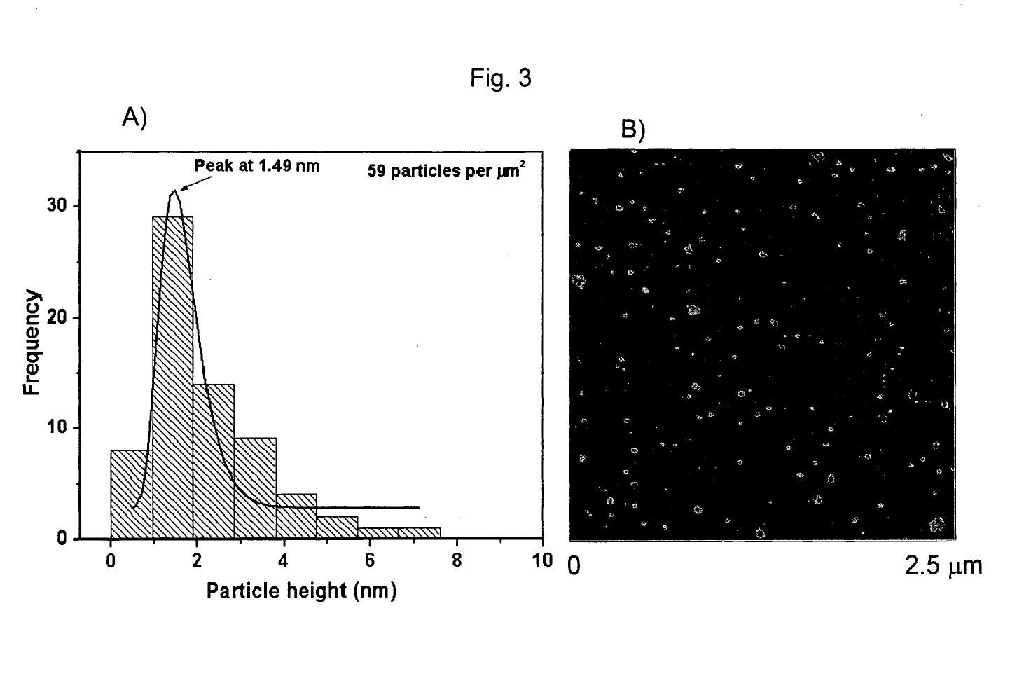

The results are presented in FIGS. 1, 2 and 3, respectively. The figures show the increase in both particle size and the concentration of particles that occurs as the concentration of the preparation solution increases.

### Example 5

Four samples of Fe:Mo catalyst at a constant 1:16 Fe:Mo ratio supported on alumina (Al₂O₃) particles were prepared by a common impregnation method using metal salts, iron (II) sulfate and (NH₄)₆Mo₇O₂₄.4H₂O, (99.999%, Alpha AESAR) dissolved in methanol, and mixed thoroughly (1 hour) with methanol suspensions of alumina (99.9%, BET surface about 90 m²/g, Degussa) at different ratios. The solvent was then evaporated and resultant cake heated to about 90 C for 3 hours under flowing nitrogen gas. The fine powders were then calcined for 1 hour at 500 C and then ground in an agate mortar. The BET surface area of final catalyst was about 43 m²/g.

By varying the concentration of catalyst on the support, the size of the resulting catalyst was varied. The concentration of the catalyst to alumina varied from a ratio of 1:5 to a ratio of 1:100. In the four samples evaluated herein, the average size of the catalyst particles was, respectively, 10±4 nm, 6±2.3 nm, 3±1 nm, and about 1 to 2 nm. A blank sample containing only alumina support was also evaluated.

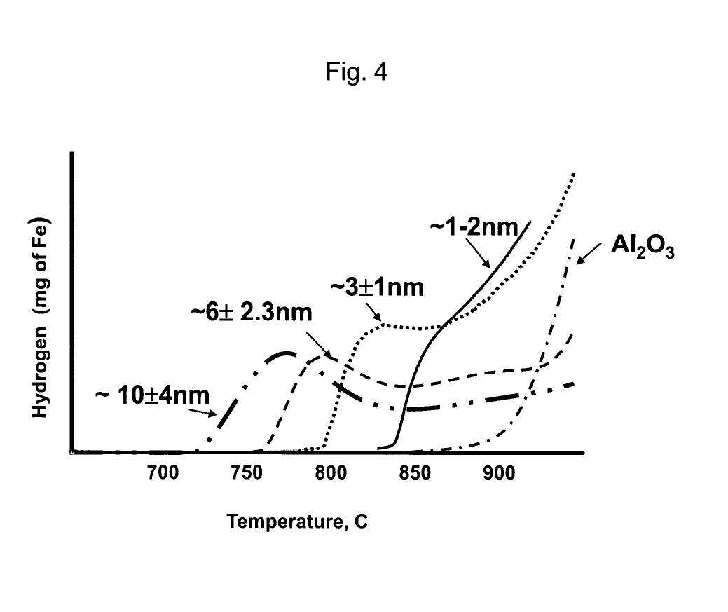

The catalytic decomposition of methane for each sample was then evaluated. The hydrogen concentration, as measured by mass spectrometry, for each of the samples and the alumina blank and is presented in FIG. 4. Only thermal decomposition of methane is believed to occur over the alumina blank sample.

As illustrated by the result presented in FIG. 4, for this Fe:Mo catalyst system, decreasing the average size of the supported catalyst particle results in an increase in the minimum temperature required for the catalytic decomposition of methane.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A method of modifying the properties of a composition comprising:
providing particles of a first composition having dimensions of less than about 3 nanometers;
providing a substrate of a second composition; and
placing the particles of the first composition on the substrate, whereby the particles of the first composition and the substrate interact to modify at least one property of the particles of the first composition relative to the same property of particles of the first composition having dimensions greater than about 10 nanometers placed on a substrate of the second composition.

2. The method according to claim 1, wherein the modified property of the first composition comprises at least one property selected from the group consisting of melting point, condensation point, electronic structure and catalytic activity.

3. The method according to claim 1, wherein the first composition comprises two or more elements.

4. The method according to claim 1, wherein the first composition comprises only one element.

5. The method according to claim 1, wherein the first composition comprises at least one element selected from the group consisting of scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead.

6. The method according to claim 1, wherein the second composition comprises at least one oxide selected from the group consisting of the oxides of magnesium, aluminum, silicon, gallium, germanium, yttrium and zirconium.

7. A method of modifying the properties of a material comprising
selecting a first material,
selecting a support material,
providing particles of the first material having dimensions of less than about 3 nanometers and a substrate of the support material,
contacting the particles of the first material with the substrate of the support material whereby the particles of the first material and the substrate interact,
wherein the first material and the support material are both selected so that when the first material is contacted with the support material, at least one property of the first material is modified to thereby exhibit at least one property similar to a property of particles of a second material supported on a substrate of the support material having dimensions of greater than about 10 nanometers.

8. The method according to claim 7, wherein the at least one property of the first material comprises at least one property selected from the group consisting of melting point, condensation point, electronic structure and catalytic activity.

9. The method according to claim 7, wherein the first material comprises two or more elements.

10. The method according to claim 7, wherein the first material comprises only one element.

11. The method according to claim 7, wherein the first material comprises at least one element selected from the group consisting of scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead.

12. The method according to claim 7, wherein the support material comprises at least one oxide selected from the group consisting of the oxides of magnesium, aluminum, silicon, gallium, germanium, yttrium and zirconium.

13. The method according to claim 7, wherein the second material comprises at least one element selected from the group consisting of ruthenium, rhodium, palladium, silver, iridium, platinum and gold.

14. The method according to claim 7, wherein the particles of the first material have dimensions of less than about 2 nanometers.

15. A method of tuning the performance of catalyst material comprising
providing particles of a first catalyst composition having dimensions of less than about 3 nanometers;
providing a first support material and a second support material;
contacting particles of the first catalyst composition with the first support material;
contacting particles of the first catalyst composition with the second support material;
wherein the respective contact between the particles of the first catalyst composition and each of the support materials modifies the catalyst performance of the particles of the first catalyst composition.

16. The method according to claim 15, wherein the first catalyst composition comprises two or more elements.

17. The method according to claim 15, wherein the first catalyst composition comprises only one element.

18. The method according to claim 15, wherein the first catalyst composition comprises at least one element selected from the group consisting of scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead.

19. The method according to claim 15, wherein each of the first support material and the second support material independently comprise at least one oxide selected from the group consisting of the oxides of magnesium, aluminum, silicon, gallium, germanium, yttrium and zirconium.

20. The method according to claim 15, wherein the catalytic performance of the first catalyst composition is similar to the catalytic performance of a second catalyst composition having particles greater than about 10 nanometers.

21. A composition comprising
particles of a component having dimensions of less than about 3 nanometers, and
a substrate of a support material,
wherein the particles and the substrate are in contact with one another, and
whereby at least one property of the particles of the component is changed by the contact with the substrate relative to the property of particles of the component having dimensions greater than about 10 nanometers in contact with the substrate.

22. The composition according to claim 21, wherein the component comprises two or more elements.

23. The composition according to claim 21, wherein the component comprises only one element.

24. The composition according to claim 21, wherein the component comprises at least one element selected from the group consisting of scandium, titanium, vanadium, chromium, manganese, iron, cobalt, nickel, copper, zinc, niobium, molybdenum, ruthenium, rhodium, palladium, silver, cadmium, indium, tin, tungsten, rhenium, iridium, platinum, gold, mercury, thallium and lead.

25. The composition according to claim 21, wherein each of the support material comprises at least one oxide selected from the group consisting of the oxides of magnesium, aluminum, silicon, gallium, germanium, yttrium and zirconium.
